(19) United States
(12) Patent Application Publication
(10) Pub. No.: US 2009/0089320 A1
(43) Pub. Date: Apr. 2, 2009

(54) CAPTURING APPLICATION STATE INFORMATION FOR SIMULATION IN MANAGED ENVIRONMENTS

(76) Inventors: Dov Tendler, Jerusalem (IL); Constantine Adarchenko, Jerusalem (IL); Yuval Mazor, Ra'anana (IL); Ofir Gilad, Mazkeret-Batya (IL)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/234,678

(22) Filed: Sep. 21, 2008

Related U.S. Application Data
(60) Provisional application No. 60/975,932, filed on Sep. 28, 2007.

(51) Int. Cl. G06F 17/30

(52) U.S. Cl. 707/102; 707/E17.044

(57) ABSTRACT

In one embodiment, a computer system to store application state data associated with a transaction between a client computing device and a server computing device comprises a processor, a memory module coupled to the processor and comprising logic instructions stored on a computer readable medium which, when executed by the processor, configure the processor to receive, from a capturing module that monitors transactions between one or more client computing devices and the server computing device a method, an object on which the method is being performed, and metadata associated with at least one of the object and the method, generate at least one method metadata message that uniquely identifies the method, generate at least one method invocation message that describes characteristics of a single method call, and generate at least one object instance that describes an instance of the object, and store the at least one method metadata message, the at least one method invocation message, and the at least one object instance in a persistent memory module.

### RELATED APPLICATIONS

This application claims priority from U.S. Provisional Application Ser. No. 60/975,932, filed Sep. 28, 2007, the disclosure of which is incorporated herein by reference in its entirety.

### BACKGROUND

With the ever increasing availability of internet access, businesses have come to rely upon network communications, such as the internet, as a means of distributing information about their businesses, as a means of advertising, and in many cases, as a means of providing services to customers and potential customers. For certain businesses, for example those in the field of retail sales via the internet, internet presence is critical to the core operation of the business itself. Businesses which do not rely upon the internet to distribute information about themselves may still use networked systems in order to provide internal access to information within the company and in order to allow efficient cooperation between co-workers located at different sites.

In setting up networked systems, whether for internal use, or for availability via the internet, it is important to test the operation of the system and the applications which run upon it. Not only must the system respond properly to individual requests for information, but any network-available resource should also be capable of operating properly when being subjected to many simultaneous requests. In addition to operating correctly when subjected to multiple requests, it is desirable to determine the speed with which the system, such as a web server, responds to requests as the load upon the system increases. Such testing to determine the ability of such a system to respond under increasing amounts of traffic is referred to as load testing.

Load testing tools are generally based on the concept of recording a client/server activity for an application-under-test, then subsequently simulating load situations by ‘replaying’ it to the server as if it were the real thing. Some load testing tools enable the running of lightweight ‘virtual users’ (VUsers) in such a way that the server cannot distinguish between them and the real application. Since each VUser consumes relatively few resources, the load testing tool performs the load simulation by running multiple concurrent VUsers on one machine, named load generator machine (LG).

### BRIEF DESCRIPTION OF THE DRAWINGS

FIG. 1 is a schematic illustration of an embodiment of a system to perform load testing of a networked information system.

FIG. 2A is a flowchart illustrating high-level operations in a method for load testing an application.

FIG. 2B is a flowchart illustrating high-level operations in a method to create a virtual user.

FIG. 3 is a flowchart illustrating operations performed during a journaling phase, according to embodiments.

### DETAILED DESCRIPTION

Described herein are exemplary systems and techniques for capturing application state information which may be used in application simulations. In some embodiments, the methods described herein may be embodied as logic instructions on a computer-readable medium. When executed on a processor, the logic instructions cause a general purpose computing device to be programmed as a special-purpose machine that implements the described methods. The processor, when configured by the logic instructions to execute the methods recited herein, constitutes structure for performing the described methods.

Throughout the description, reference will be made to various implementation-specific details. These details are provided to fully illustrate a specific embodiment of the invention, and not to limit the scope of the invention. The various processes described herein are preferably performed by using software executed by one or more general-purpose computers. The processes could alternatively be embodied partially or entirely within special purpose hardware without altering the fundamental system described.

In particular, a “module” as used herein, may refer to any combination of software, firmware, or hardware used to perform the specified function or functions. The modules described herein are preferably implemented as software modules, but may be represented partially or entirely in hardware or firmware. It is contemplated that the functions performed by these modules may also be embodied within either a greater or lesser number of modules than is described in the accompanying text. For instance, a single function may be carried out through the operation of multiple modules, or more than one function may be performed by the same module. The described modules may be implemented as hardware, software, firmware or any combination thereof. Additionally, the described modules may reside at different locations connected through a wired or wireless network, or the Internet.

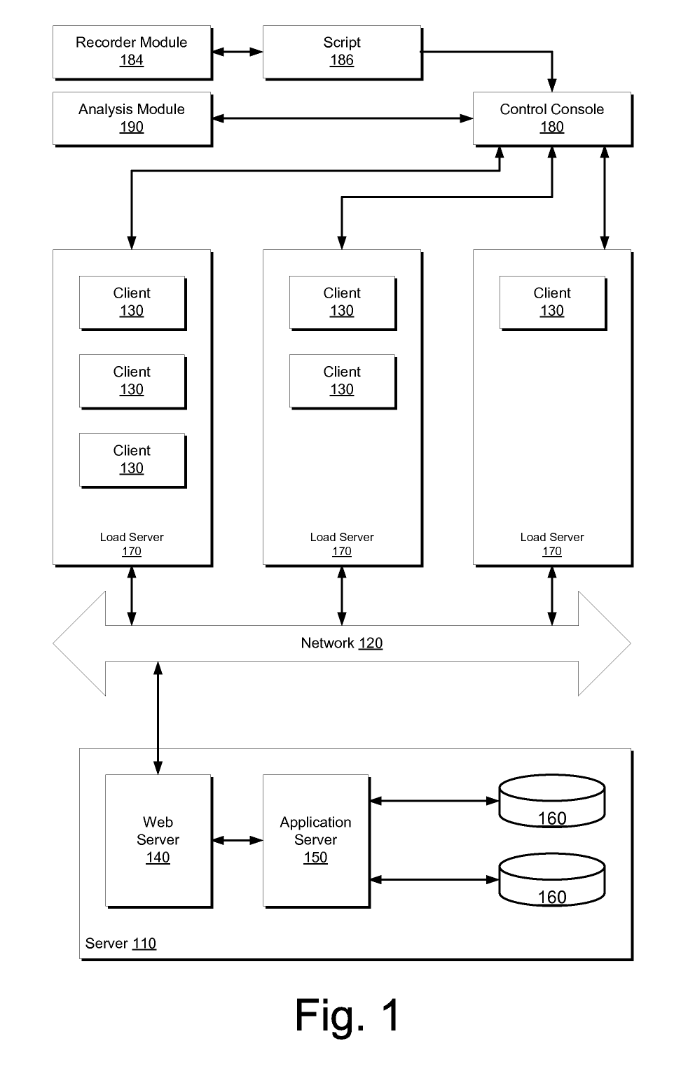

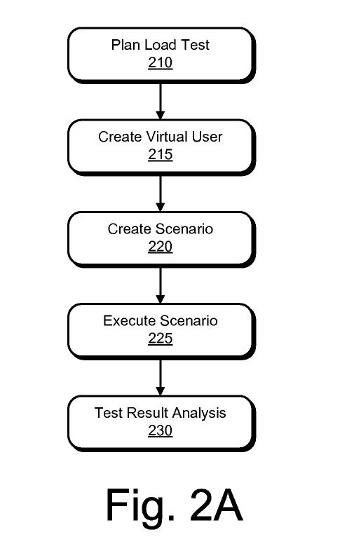

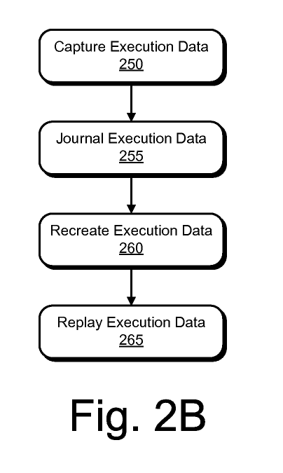

In some embodiments, the systems and methods may be implemented within the context of a system to perform load testing on a network-based computer information system. Aspects of load testing and a technical context in which load testing may be performed will be explained with reference to FIG. 1 and FIG. 2. FIG. 1 is a schematic illustration of an embodiment of a system to perform load testing of a networked information system FIG. 2 is a flowchart illustrating high-level operations in a method for load testing an application.

Referring first to FIG. 1, in one embodiment a load testing system may be implemented as a client/server system in which requests are made by clients of a server and information is sent back to the clients from the server. The load testing which is performed can generally be used to test the responsiveness of a particular server (as discussed below), as well as to test the connections between the clients and the server. Because any test input to the server must pass along the network, the network is effectively part of each test to the extent that network problems will show up as problems in the responsiveness of the server. However, by analyzing the data produced during load testing, network related bottlenecks can be identified and separated from any actual problems associated with the operation of the server itself. This will be discussed in greater detail below.

Referring to FIG. 1, the server 110 is connected to a communications medium in order for the server 110 to communicate with any clients. The illustrated communications medium is a communication network 120, which may be a public network such as, e.g., the Internet, or a private communication network such as, e.g., a corporate communication network. Various clients 130 connect through the communications medium to the server 110. Each client 130 may represent an individual user of the system under actual use, or may, as will be discussed below, represent a virtual client (i.e., a VUser) which is simulating the behavior of an individual user for testing purposes. In addition to the system shown in FIG. 1, in which the load testing is performed remotely over the internet (e.g. using a hosted load testing service), it is also possible to perform load testing using a local network upon which both the tested server 110 and the clients 130 reside. In this instance, an in house or other private network may have the appropriate load testing software loaded onto particular computers and run locally upon the network. This latter arrangement may be particularly advantageous for pre-deployment testing of servers 110 or other systems for which it is desirable to not expose the tested system 110 to the network 120 prior to the completion of testing. One skilled in the art will appreciate that application(s) executing on clients 130 may access more than one server 110. In practice there may be multiple servers involved in an application testing scenario.

As shown in FIG. 1, the server 110 undergoing testing may comprise a number of sub-components. These may include a web server 140, an application server 150, and one or more databases 160. The web server 140 handles incoming requests from clients 130 and presents an interface to a client of the system for interacting with the server 110. The application server 150 processes the requests made of the server 110 which are passed to it by the web server 140. The databases 160 store information related to the operation of the application server 150, and provide it to the application server. Although the system under test 110 illustrated in FIG. 1 is a web-based server system, the described system and techniques are also applicable to other types of network-based multi-user systems, which may communicate using a variety of networking and communications protocols.

In one embodiment of the system as described herein, the server being tested may represent a web server or other system designed to be communicated with via HTTP (HyperText Transport Protocol), or a variant thereof. This web server may be configured to output display pages formatted using HTML (HyperText Markup Language) encoded web pages for display by a client program such as a web browser.

As used herein, the terms, “web server”, “application server”, and “database” may refer to a process being run on a computer or other hardware which carries out a specific function, or may refer to the system upon which this function is performed. Those of skill in the art will recognize that despite being shown as separate elements in FIG. 1, the web server 140, application server 150, and databases 160 may be run on one or more machines as is appropriate to the function being performed. For instance, for small scale operations, it may be reasonable to run the application server 150 and the database 160 as separate processes on a single computer. Larger operations may require multiple databases 160 run on separate computers to support a single application server 150 running on still another computer. Variations in such internal architecture of the server 110 do not substantially alter the nature of the system described herein.

Also shown in FIG. 1 are a number of load servers 170. A load server is a computer which supports one or more virtual clients 130. In ordinary operation of a client/server system, the amount of load on the server 110 is directly related to the number of individual client processes simultaneously making requests of the server 110. In such ordinary circumstances, each client process represents a single user interacting with the server. For example, one process contains multiple threads, each of which represents a virtual client. However, in order to perform load testing, it is desirable for the load to be generated without requiring a large number of individual users to be working simultaneously, and also to not require a large number of individual computers acting as clients to the server 110.

To accomplish this, each load server 170 simulates the behavior of one or more clients 130, and sends and receives information to and from the server 110 as if were a number of individual clients. By using virtual clients 130 running upon load servers 170, it is possible for a smaller number of load servers 170 to generate a load upon the server which is equivalent to the load generated by a larger number of individual users during ordinary use.

A control console 180 links to each load server 170 and governs the operation of the load servers. The control console may comprise a computer or other hardware executing a program that allows a user overseeing the load testing to configure the operation of each load server, including the type and number of virtual clients 130 for each load server to simulate, as well the timing of the load testing. The control console may also allow a user to view the results of the load testing, and monitor the operation of the testing as it is performed.

An analysis module 190 may also be connected to the control console 180. The analysis module 190 may be run on a separate computer system which has access to the results of the load tests performed by the control console 180, or may simply be a separate software module which runs upon the same system as the control console 180. The analysis module 190 may also be run on a load server 170. Such an arrangement may be particularly advantageous when only a single load server 170 is used for the test session.

The analysis module 190 may perform automated analysis of the results of one or more load test sessions in order to present information indicating various ways in which the configuration of the server 110 may be optimized, or to determine the performance bottlenecks of the server 110.

Although not shown in FIG. 1, it will also be understood that other components may be used in this system in addition to, or in place of, some of the components shown. For example, routers and switches will handle the data as it passes between the various load servers 170, the server 110, and the network 120. Firewalls may also be located between various systems to protect individual systems from undesirable access being made via a connection to the network 120 or another connecting communications medium. Similarly, load balancers may be used to properly handle traffic throughout the system, and various storage devices may be used.

Furthermore, although direct connections are shown between individual systems, such as between the control console 180 and the load servers 170, those of skill in the art will recognize that the network 120 or a similar communications medium may be used to connect all of the systems shown in FIG. 1 together. The connections shown in FIG. 1 represent the flow of data rather than physical connections between the systems shown.

As mentioned above, each client 130 makes requests of the server 110, and receives information back from the server. When performing automated testing, it is desirable to configure the virtual clients 130 to make various requests in the same manner as actual clients would, but without the local overhead associated with user interaction. Two types of simulation that may be used for most client/server applications include a playback technique and a simulated interface.

Using a playback technique, it is possible to simulate a client by recording and playing back a series of direct calls to the server such as would be made by an actual client without running the actual client process. In this way, the server performs the same operations that would be performed if such requests were being made by a full client. However, the client being used to perform the playback need not actually do all of the local processing normally associated with making those server calls; they can simply be sent at the appropriate times and then wait until the response to the server call is received. Such a system may also measure the delay until the response is received, although those of skill in the art will recognize that appropriate software on the server may also monitor the delay between the receipt of a request and the sending of a response. The difference between the delay as measured by the client and the delay as measured by the server is always the time the messages spent in transit between the client and server.

The simulated interface method involves preparing an interface, such as would be used by a client being used to access the server, and then simulating the operation of that interface on the local system and allowing the calls which would be made via that simulated client interface to be made to the server. Although such a technique involves actual simulation of the interface used by the client program, there is no need to display the interface or otherwise cause the actual interface to be shown as it would to a user. By appropriate simulation, it is therefore possible to allow multiple simultaneous client processes to be simulated on a single load server (as discussed below), without the need to display or operate a number of user-operable client processes on the load server system.

The user may configure each individual virtual client 130 on each load server 170 to carry out certain tasks and make particular requests of the server 110. By setting up different sequences of operations for the clients 130, the user may present the server with a load which simulates whatever type of user population is desired. When simulating a gaming server, for instance, it might simply be desirable to simulate 50 clients all connected and sending requests consistent with the playing of the same network game. However, in simulating an online merchant's typical traffic, the virtual clients could be configured to send messages which corresponded to the server traffic expected when there were 100 users simultaneously browsing the merchant's web site, 10 users simultaneously making purchases, and 5 users simultaneously reviewing their account histories. By allowing different virtual clients to have different types of server requests, a more accurate modeling of the user population may be created for use with the server for testing.

The virtual clients 130 may also be configured to incorporate delays to simulate the time a user spends responding to each bit of new information presented, as well as to wait for particular times or events before proceeding, in order that a large load may be applied to the server all at once. Such behavior will also allow the test session to be configured to most precisely simulate the load on the server to be tested.

Once the individual clients 130 have been configured, and each load server is set up to simulate as many virtual clients as desired, a test session may be initiated. During a test session, each load server 170 runs its virtual clients 130 and interacts with the server 110. A single session may be ended by reaching the end of the programmed test profile, by user intervention, or by the server 110 crashing.

In an exemplary test session, the server 110 being tested is subjected to a series of client requests from the virtual clients 130 generated by the various load servers 170. As the test session runs, the load, as represented by the number of client requests made of the server 110, is increased. Throughout the run, various measurements are recorded by both the virtual clients 130 and the server 110, and these measurements are sent back to the control console 180, where they are recorded. The measurements can represent a variety of performance metrics, referred to as ‘monitors’. These monitors can include, without limitation: the response time for a client transaction, the number of successful transactions per second by the server, the number of failed transactions per second, the total throughput of the server 110, and such other measurements as would be known to one of skill in the art.

A single test session may run a specific set of test patterns on specified load servers 170, or may be configured to continue to increase the load upon the server 110 until such time as the server 110 is unable to handle further load and crashes. In either event, a set of results are collected from the each test session. These results may comprise one or more series of measurements of monitor values as indicated above, each measurement paired with the time corresponding to the measurement.

This data is collected and stored for later access by the analysis module, described below. Those of skill in the art will recognize that the data need not be stored on the control console 180 itself, but might be stored in any repository which is accessible to the control console 180 and analysis module 190, and which can be written to from the load servers 170 and such other systems or processes that measure the values of the various performance monitors.

Multiple test sessions may be run, and the monitor data saved from each. In addition, test sessions may be run using various configurations, and the data from each different test session sent to the same console 180. These varying configurations may include differences in network configuration, such as router or firewall settings, or changes in network topology. Other types of varied configurations may include changes in the number of individual client processes 130 that are used in the test, or in the profile of the requests made by the clients. Still further variations may include the type of request being made of the server by the clients.

Additional details of components and testing methods that may be used to load test the information system 110 are set forth in U.S. patent application Ser. No. 09/484,684, filed Jan. 17, 2000, and Ser. No. 09/565,832, filed May 5, 2000, the disclosures of which are hereby incorporated by reference.

The monitor data collected in an individual test session may be made available from the control console 180, or from any other system which captures and stores this data, to the analysis module 190. For example, in addition to monitor data collected as described above, monitor data may also be read from other sources of performance measurements. For instance, if monitor data is available from the internal logging feature of a program, such as a database server, this data may also be read and integrated into the body of data being analyzed in the analysis module.

The monitor data from each source may be passed along to the analysis module in real time, or may be stored and forwarded at a later time to the analysis module 190. The analysis module 190 may also receive data from multiple control consoles 180 responsible for different test sessions of one or more servers 110. The data may also be made available to the analysis module 190 upon a request from the analysis module 190 to one of the various control consoles 180 or other systems which store such data. Those of skill in the art will recognize that the nature of the analysis is not changed by the manner in which the data is received by the analysis module 190.

As mentioned above, the data received by the analysis module 190 may desirably comprise a series of measurements paired with a time stamp corresponding to such time within the test session at which that measurement was taken. Because each measurement of a monitored value is indexed to a particular time stamp within a particular test session, it is possible to associate the values of one monitor with those of another monitor taken at the same time. By aligning those monitors which represent simultaneous measurements, the relationships between the various monitors may be determined.

The operations depicted in FIG. 2A present an overview of the load testing process. Referring to FIG. 2A, at operation 210 the load test is planned. For example, one or more specific applications on a client computer may be selected for load testing. At operation 215 one or more virtual users (VUsers) is created. The creation of VUsers is discussed in greater detail below. At operation 220 a test scenario is created and at operation 225 the test scenario is executed. At operation 230 the test results may be analyzed.

Many business applications comprise several discrete functional modules: GUI, business logic, server communications, network access, etc. A single protocol is meant for recording and replaying a script at a distinct level; the closer this level is to raw network activity, the more scalable the resulting script is. On the other hand, understanding the business logic implemented by a script requires the script to be recorded at a higher level, i.e., closer to the actual application user's actions.

The NET Framework is a Microsoft development environment meant to improve and ease the development cycle for a large variety of applications implementing many different techniques and paradigms. Much like Java, it offers a managed runtime environment (i.e., the Common Language Runtime or CLR) that reduces the amount of ‘plumbing’ work required by the developer and allows her to concentrate on the business value instead. The large market acceptance enjoyed by the .NET Framework introduced the need for a viable load testing solution that can be used by testing teams independent of the developer group.

FIG. 2B is a flowchart illustrating high-level operations in a method to create a virtual user (see operation 215). The method comprises four main operations. At operation 250 execution data associated with an application is captured. In some embodiments, the capturing operation implements a filtering mechanism which specifies what classes and/or methods constitute significant client/server activity. Filter configuration information may be provided from either the end user who is familiar with the internals of the application under test and/or built-in handling for specific environments (i.e., ADO.Net or .Net Remoting).

In some embodiments capturing may be implemented using the principle of instrumentation, i.e. the altering of a method's compiled byte code during runtime. For example, the standard .Net profiler interface may receive notifications from the CLR on methods that are about to be Just-In-Time compiled. At this point, a configuration filter may select the method and add a set of byte-code instructions to the start of the method's body. These instructions may be written in MSIL (the Microsoft Intermediate Language), which is the CLR's equivalent to the CPU's native assembly language At a later time, once this compiled method is called, the injected code will transfer control to a custom hook. This hook may be located in a separate assembly, of which the original application is unaware.

At operation 255 the execution data is journaled. Once the method being run is known, its context and arguments may be analyzed, and this information may be saved in persistent storage. In particular, this information describes live objects and variables, but be stored and managed outside the application itself. The data will ultimately be used for generating output that is semantically equivalent to the client/server activity performed during the capturing stage. Additional details about the journaling operation are discussed below.

At operation 260 the execution operations are recreated to generate a representation of the application's state at points where significant client/server activity took place, which in turn enables the generation of output source code. This code, may be compiled using standard development environments and tools (i.e., .Net language compilers, Visual Studio.Net, etc.) and run, interacts with the server as if it were the original application.

Once the application state information is serialized into messages stored persistently, compilable code may be created that simulates the application's client-server activity. In one embodiment a chain of handlers process the recorded messages. The final handler in this chain creates the actual code, the relevant solution and the project files to make it compilable (e.g., for the specific implementation for the .Net Framework these are the Visual Studio sIn and .csproj/.vbproj files).

In one embodiment a system may include a code-generation handler mechanism which provides infrastructure for generating a final script. A solution for the .Net environment contains, among others, the following enhancements over code generated directly from the recorded messages.

For example, .NET Remoting is a facility that enables developers to perform remote object calls that look almost identical to local object calls. However behind the scenes, a complex sequence of proxy messages is exchanged between the local and remote machines, so that the standard instrumentation mechanism does not apply. The facility analyzes messages between the proxy object on the client side and the remote object on the server side, and output code that resembles what the application programmer actually wrote.

Similarly, ADO.Net is standard Data Access methodology for the .Net Framework. By reviewing message data the contents of data may be displayed, inline in the script, sent to and from the server. Further, common usage patterns such as iterative data access (that is, method call sequences that repeatedly call DataReader.Read( ) for retrieving the next row in the table) may be detected and converted into single methods that are semantically equivalent but are more readable to the user.

At operation 265 the execution data is replayed. In order to implement a successful and meaningful load-testing scenario, many instances of the final compiled code may be run concurrently. Each instance may be referred to as a virtual user (VUser). However, each such VUser must act as if it were the only instance of the application running on the machine. In some embodiments, each VUser runs in a separate AppDomain, which is a .NET Framework abstraction for a logical process boundary contained in a physical OS process. Each AppDomain is set up to run as if it were the application; for instance, if the application searches for files stored in a specific layout on the disk, a VUser will perform the same logic, taking into account the original application's configuration files.

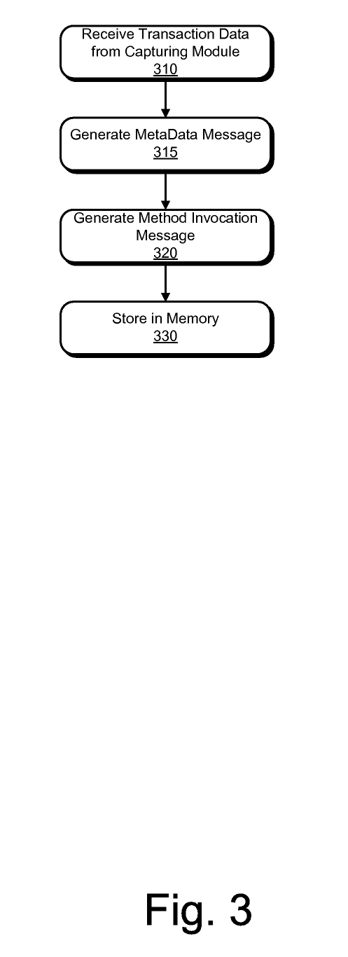

In some embodiments, the system implements methods as part of the journaling operation (255) to describe instances of live objects and the method invocations performed on them while maintaining state information as well as object identity. FIG. 3 is a flowchart illustrating operations performed during a journaling phase, according to embodiments. Referring to FIG. 3, at operation 310 transaction data is received. At operation 315, at least one metadata message based on the transaction data is generated, and at operation 320 at least one method invocation message is generated.

Metadata messages uniquely identify the method being called. As used in this context, the term metadata refers to the method name, its prototype, the type (i.e., class) in which it is defined and/or the type in which it is implemented. In one embodiment, the managed environment's reflection API may be used to obtain and represent the metadata. This allows the environment's round-tripping capabilities to be used for ‘restoring’ the method outside of the running application.

In one embodiment, there are three messages available in the metadata message set. These messages and their contents are summarized in Table I, below:

TABLE I
Metadata Message Set

| | |
|---|---|
| 1. | AssemblyInfo - Used to describe an assembly |
| | Contents: |
| | ID - unique ID number assigned |
| | Name |
| | Location |
| | IsInGac (Global Assembly Cache) |
| 2. | TypeInfo - Used to describe a type (class, interface or structure), |
| | possibly a generic type specialization |
| | Contents: |
| | ID - unique ID number assigned |
| | AssemblyRef - Reference to ID field in AssemblyInfo message |
| | MetadataToken - the token supplied by the managed environment |
| | for representing this type in a module |
| | ModuleName - name of module inside the assembly in which this |
| | type is defined |
| | GenericParameters - list of ID's of TypeInfo messages describing |
| | the generic type specializations used for this particular type |
| | instance |
| | DisplayName - used for debugging and logging only |
| 3. | MethodInfo - Used to describe a specific method, possible a generic |
| | method specialization |
| | Contents: |
| | ID - unique ID number assigned |
| | TypeRef - Reference to ID field in TypeInfo message |
| | MetadataToken - the token supplied by the managed environment |
| | for representing this method in a type |
| | GenericParameters - list of ID's of TypeInfo messages describing |
| | the generic type specializations used for this particular method |
| | specialization |
| | DisplayName - used for debugging and logging only |

At operation 320 the control console generates at least one method invocation message based on the transaction data received from the capturing module. The method invocation message set is a set of messages is used for describing a single method call. In one embodiment, the set contains a single message type, of which a major part is describing the actual objects instances involved in the method invocation. The messages available in this set are summarized in Table 11, below:

TABLE II
Method Invocation Message Set

```
MethodCall
Contents:
  Header - General runtime information pertaining to this method call:
  process and thread ID's and start/end timestamps.
  MethodRef - Reference to ID number of MethodInfo message. Note:
  when dealing with inheritance, this field refers to the actual method
  being called - that is, if a derived class does not override the base
  implementation, this field will point to the MethodInfo of the base class.
  ThisInstance - An ObjectInstance (see below) describing
  the ‘this’ object on which the
  method was called. For the case of inheritance, the
  TypeRef inside this ObjectInstance will point to the type of the derived
  class.
  InArguments - List of ObjectInstances describing the input arguments of
  the method call.
  OutArguments - List of ObjectInstances describing the output arguments
  of the method call.
  RetVal - ObjectInstance describing the return value of this method.
  Attributes - Zero or more key-value pairs used for sending additional
  information about the method call that might be interesting for post-
  processing. (For example, a stack trace for the method call.)
```

At operation 320 one or more object instances are generated from the transaction data received from the capturing module. In one embodiment, live object instances are represented using an abstract class, ObjectInstance, which contains data pertaining to an arbitrary object instance. From this abstract class various other classes that contain specific information for idealized categories of objects may be derived. This hierarchy may be recursive when a given ObjectInstance requires another ObjectInstance to describe itself.

In one embodiment, the contents of the abstract ObjectInstance class are summarized in Table 111, below:

TABLE III
ObjectInstance Class

```
ObjectInstance class:
  ID - Unique ID number for this object instance (assigned by us)
  TypeRef - Reference to the TypeInfo ID for this object's basic
  type (that is, without arrays or references)
  Kind - The category (see below) into which this object falls
  ObjValue - The value of this object. This field has different contents
  depending on the Kind field above.
  Attributes - Zero or more key-value pairs used for sending additional
  information about this object.
```

In one embodiment, the system implements a chain-of-responsibility pattern to decide which category a particular object falls into. The categories, in the order in which they are queried, are as follows (each such category is marked with a unique value in the Kind field above):

TABLE IV
Object Categories

| | |
|---|---|
| 1. | NullInstance - This class represents the single NULL value in the |
| | managed environment. |
| | Contents: |
| | N/A |
| | Notes: |
| | This category does not require the ID field to be filled in, as there is |
| | only a single unambiguous NULL value |
| 2. | SystemPrimitiveInstance - This class represents primitive values (int, |
| | float, etc.) in the managed environment. A String |
| | type is also considered to be primitive, |
| | although the managed environment may not treat it as such. |
| | Contents: |
| | Value - The actual value of the primitive |
| 3. | RefInstance - This class represents a reference to an object instance |
| | that has been seen before and in particular, has already been |
| | assigned a unique ID. |
| | Contents: |
| | ID - The ID value for this object, as assigned by the NewInstance |
| | category (see below). |
| | Notes: |
| | The Value field for this category is empty. |
| 4. | ObjectPrimitiveInstance - This class represents an object type that |
| | is not treated as primitive by the runtime, yet has a value that can be |
| | treated as primitive. For instance, the types URI, GUID and |
| | DateTime all have an internal structure that can be represented |
| | by a real primitive value. These types allow creation of |
| | instances directly from this primitive value. |
| | Contents: |
| | Same as SystemPrimitiveInstance |
| 5. | DelegateInstance - This class represents a delegate, which is a |
| | managed environment's equivalent to a function pointer. |
| | Contents: |
| | Method - ID of the MethodInfo message to which this delegate is |
| | referring |
| | Target - The ID of the ObjectInstance on which the Method field |
| | above is to be called |
| 6. | ArrayInstance - This class represents an array of ObjectInstances. |
| | Contents: |
| | Data - An array of ObjectInstances, representing the elements |
| | of the array |
| | Ranks - Array of integers, representing the dimensions of the array |
| 7. | ListInstance - This class represents a list (or vector) of |
| | ObjectInstances. |
| | Contents: |
| | Data - A list of ObjectInstances, representing the elements of |
| | the list |
| 8. | DictionaryInstance - This class represents a map of |
| | ObjectInstances. |
| | Contents: |
| | Data - A list of key, value pairs, representing the keys and values |
| | of the map. Both keys and values are themselves ObjectInstances. |
| 9. | SerializeableInstance - This class represents an object that can be |
| | serialized using the managed environment's standard serialization |
| | mechanism. |
| | Contents: |
| | FileName - Name of file the runtime uses for serialization/ |
| | deserialization |
| 10. | SimpleObjectInstance - This class represents an object that is of |
| | a ‘simple’ type. A simple type is defined as having an empty |
| | constructor and only public fields, which must themselves be simple. |
| | In particular, a primitive is a simple type. |
| | Contents: |
| | Data - a list of name, value pairs representing the field names and |
| | values of the object. The name of a field is a string while the value |
| | is an ObjectInstance (which may be a SimpleObjectInstance itself) |
| 11. | NewInstance - This class represents an instance of a type that has |
| | been ‘seen’ for the first time. It is assigned a unique ID value that |
| | can later on be used for referring to this particular instance. |
| | Contents: |
| | ID - Unique ID assigned to this instance |

Once the metadata message(s), the method invocation message(s), and the object instance(s) are created, they are stored (operation 330) in a memory location. In some embodiments the memory location may be a persistent memory location such as, e.g., memory on a disk drive or the like. Subsequently, the metadata message(s), the method invocation message(s), and the object instance(s) may be used to recreate the application state in a simulation of the process(es) executing on a server during load testing of the server.

Thus, live object(s) from a transaction data capturing module are passed through a chain of handlers whose task it is to create the best ObjectInstance category for describing this object. The handlers implement a rule-based analysis which takes into account, among other things, the role, i.e., whether the object is a method parameter, the ‘this’ object or the method's return value, the direction, i.e., is the object being processed before or after the actual method call, and the type modifier, i.e., whether the object a reference or value type.

Embodiments described herein may be implemented as computer program products, which may include a machine-readable or computer-readable medium having stored thereon instructions used to program a computer (or other electronic devices) to perform a process discussed herein. The machine-readable medium may include, but is not limited to, floppy diskettes, hard disk, optical disks, CD-ROMs, and magneto-optical disks, ROMs, RAMs, erasable programmable ROMs (EPROMs), electrically EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Additionally, some embodiments discussed herein may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment is included in at least one implementation. The appearances of the phrase “in one embodiment” in various places in the specification are not necessarily all referring to the same embodiment.

What is claimed is:

1. A method to store application state data associated with a transaction between a client computing device and a server computing device, comprising:
receiving, from a capturing module that monitors transactions between one or more client computing devices and the server computing device:
a method;
an object on which the method is being performed; and
metadata associated with at least one of the object and the method;
generating at least one method metadata message that uniquely identifies the method;
generating at least one method invocation message that describes characteristics of a single method call; and
generating at least one object instance that describes an instance of the object; and
storing the at least one method metadata message, the at least one method invocation message, and the at least one object instance in a persistent memory module.

2. The method of claim 1, wherein generating at least one method metadata message comprises:
generating at least one of
an AssemblyInfo message;
a TypeInfo message; and
a MethodInfo message; and
assigning a unique identifier to the method metadata message.

3. The method of claim 1, wherein generating at least one method invocation message that describes characteristics of a single method call comprises generating a MethodCall message that comprises:
a header field that contains runtime information pertaining to the method call;
an ObjectInstance field that contains data describing an object instance in which the method was invoked;
zero or more input arguments supplied to the method;
zero or more output arguments provided by the method; and
at most one return value provided by the method.

4. The method of claim 1, wherein the at least one object instance that describes an instance of the object comprises at least one of:
an identifier that uniquely identifies the object instance a reference to a TypeInfo identifier;
an object kind category identifier; and
an object value.

5. The method of claim 5, wherein the object kind category comprises at least one of:
a NullInstance;
a SystemPrivitiveInstance;
a RefInstance;
an ObjectPrimitiveInstance;
a DelegateInstance;
an ArrayInstance;
a ListInstance;
a DictionaryInstance;
a SerializableInstance;
a NewInstance.

6. The method of claim 1, further comprising:
retrieving the at least one method metadata message, the at least one method invocation message, and the at least one object instance in a persistent memory module; and
recreating the at least one transaction between a client computing device and a server computing device using the at least one method metadata message, the at least one method invocation message.

7. The method of claim 1, wherein the at least one method metadata message, the at least one method invocation message, and the at least one object instance are used to generate output code which may be opticmized for one or more usage patterns.

8. A computer system to store application state data associated with a transaction between a client computing device and a server computing device, comprising:
a processor;
a memory module coupled to the processor and comprising logic instructions stored on a computer readable medium which, when executed by the processor, configure the processor to:
receive, from a capturing module that monitors transactions between one or more client computing devices and the server computing device:
a method;
an object on which the method is being performed; and
metadata associated with at least one of the object and the method;
generate at least one method metadata message that uniquely identifies the method;
generate at least one method invocation message that describes characteristics of a single method call; and
generate at least one object instance that describes an instance of the object; and
store the at least one method metadata message, the at least one method invocation message, and the at least one object instance in a persistent memory module.

9. The computer system of claim 8, further comprising logic instructions stored on a computer readable medium which, when executed by the processor, configure the processor to:
generate at least one of:
an AssemblyInfo message;
a TypeInfo message; and
a MethodInfo message; and
assign a unique identifier to the method metadata message.

10. The computer system of claim 8, further comprising logic instructions stored on a computer readable medium which, when executed by the processor, configure the processor to generate a MethodCall message that comprises:
a header field that contains runtime information pertaining to the method call;
a ObjectInstance field that contains data describing an object instance in which the method was invoked;
zero or more input argument supplied to the method;
zero or more output argument provided by the method; and
at most one return value provided by the method.

11. The computer system of claim 8, wherein the at least one object instance that describes an instance of the object comprises at least one of:
an identifier that uniquely identifies the object instance
a reference to a TypeInfo identifier;
a object kind category identifier; and
an object value.

12. The computer system of claim 8, wherein the object kind category comprises at least one of:
a NullInstance;
a SystemPrivitiveInstance;
a RefInstance;
an ObjectPrimitiveInstance;
a DelegateInstance;
an ArrayInstance;
a ListInstance;
a DictionaryInstance;
a SerializableInstance;
a NewInstance.

13. The computer system of claim 8, further comprising logic instructions stored on a computer readable medium which, when executed by the processor, configure the processor to:
retrieve the at least one method metadata message, the at least one method invocation message, and the at least one object instance in a persistent memory module; and
recreate the at least one transaction between a client computing device and a server computing device using the at least one method metadata message, the at least one method invocation message.

14. The computer system of claim 8, wherein the at least one method metadata message, the at least one method invocation message, and the at least one object instance are used to generate output code which may be opticmized for one or more usage patterns.

15. A computer program product comprising logic instructions stored on a computer readable medium which, when executed by the processor, configure the processor to store application state data associated with a transaction between a client computing device and a server computing device by performing operations, comprising:
receiving, from a capturing module that monitors transactions between one or more client computing devices and the server computing device:
a method;
an object on which the method is being performed; and
metadata associated with at least one of the object and the method;
generating at least one method metadata message that uniquely identifies the method;
generating at least one method invocation message that describes characteristics of a single method call; and
generating at least one object instance that describes an instance of the object; and
storing the at least one method metadata message, the at least one method invocation message, and the at least one object instance in a persistent memory module.

16. The computer program product of claim 15, further comprising logic instructions stored on a computer readable medium which, when executed by the processor, configure the processor to generate least one of:
an AssemblyInfo message;
a TypeInfo message; and
a MethodInfo message.

17. The computer program product of claim 15, further comprising logic instructions stored on a computer readable medium which, when executed by the processor, configure the processor to assign a unique identifier to the method metadata message.

18. The computer program product of claim 15, further comprising logic instructions stored on a computer readable medium which, when executed by the processor, configure the processor to generate a MethodCall message that comprises:
a header field that contains runtime information pertaining to the method call;
a ObjectInstance field that contains data describing an object instance in which the method was invoked;
at least one input argument supplied to the method;
at least one output argument provided by the method; and
at least one return value provided by the method.

19. The computer program product of claim 15, wherein the at least one object instance that describes an instance of the object comprises at least one of:
an identifier that uniquely identifies the object instance
a reference to a TypeInfo identifier;
a object kind category identifier; and
an object value.

20. The computer program product of claim 15, further comprising logic instructions stored on a computer readable medium which, when executed by the processor, configure the processor to:
retrieve the at least one method metadata message, the at least one method invocation message, and the at least one object instance in a persistent memory module; and
recreate the at least one transaction between a client computing device and a server computing device using the at least one method metadata message, the at least one method invocation message.
